(19) United States
(12) Patent Application Publication
(10) Pub. No.: US 2013/0034819 A1
(43) Pub. Date: Feb. 7, 2013

(54) Delayed Coking Process

(71) Applicant: Kenneth A. Catala, Whippany, NJ (US)

(72) Inventor: Kenneth A. Catala, Whippany, NJ (US)

(73) Assignee: LUMMUS TECHNOLOGY INC., Bloomfield, NJ (US)

(21) Appl. No.: 13/641,184

(22) PCT Filed: Apr. 8, 2011
(86) PCT No.: PCT/US11/31662

§ 371 Date: Oct. 15, 2012

Related U.S. Application Data
(60) Provisional application No. 61/324,625, filed on Apr. 15, 2010.

(51) Int. Cl. F27D 1/00; F27D 19/00; F27D 21/00

(52) U.S. Cl. 432/29; 432/247; 432/120; 432/32; 432/36

(57) ABSTRACT

A delayed coking heater for heating a feedstock to delayed coking temperature is disclosed. The delayed coking heater may include: a heater including a radiant heating zone comprising a lower portion including a hearth burner section and an upper portion including a wall burner section, the hearth burner section comprising a plurality of hearth burners located adjacent to the bottom hearth for firing in the radiant heating zone; and the wall burner section comprising a plurality of wall burners located adjacent to opposing walls; and a multiple parallel serpentine heating coil located in the radiant heating zone.

### FIELD OF THE DISCLOSURE

In one aspect, embodiments disclosed herein relate to the production of coke from liquids containing compounds that may be cracked to produce carbon. In another aspect, embodiments disclosed herein relate to a process known as delayed coking. In another aspect, embodiments disclosed herein relate to a delayed coking heater having a multiple parallel serpentine heating coil for use in heating the coking feedstock.

### BACKGROUND

Coking can be considered to be a severe thermal cracking process in which one of the end products comprise carbon, i.e. coke. The delayed coking process was initially developed to minimize refinery yields of residual fuel oil by severe cracking of feedstocks such as vacuum residuals and thermal tars to produce coke and lower molecular weight hydrocarbons. U.S. Pat. Nos. 4,049,538 and 4,547,284, the disclosures of which are incorporated herein by reference, show examples of delayed coking processes.

The delayed coking process generally involves heating the feedstock in the conduit or tubing of a tube heater to a temperature above the cracking temperature while feeding the feedstock at a high velocity through the conduit. The optimum operation involves the use of feed rate such as to minimize the actual formation of carbon in the heated conduit of the tube heater. The tube heaters are often referred to interchangeably as coker heaters or coker preheaters.

In U.S. Pat. No. 4,049,538, a coker preheater is illustrated diagrammatically as item number 11. In U.S. Pat. No. 4,547,284, a coker heater is illustrated diagrammatically as item number 25. The heated feedstock at the coking temperature is passed from the heating zone to a coke drum wherein preferably the majority of the coke formation takes place. In the insulated coke drum, or surge drum, a sufficient residence time allows the coking to take place. Typically, the heated coking feedstock has been heated to a temperature sufficient to maintain the coking in the drum, i.e. temperature in the range of about 750 to about 975° F. As the process proceeds, coke accumulates in the coking drum and is later removed by techniques known in the art.

Although much effort has been devoted in the past to providing conditions which will allow for the delayed coking feedstock to be heated to the cracking temperature without the formation of undesirable carbon deposits in the conduit of the coker heater, carbon deposition in the conduits of the coker heater still continues to be a problem.

In addition to the desire to avoid carbon deposition in the coker heater, it is also desired to increase the capacity of the delayed coking units. The original design for delayed coking units consisted of small, box-shaped heaters with rows of tubes suspended from the roof and a row of tubes on each wall, with the tubes being heated only in the radiant section of the heater.

Contemporary delayed coking units include a double-fired coker heater design, such as described in U.S. Pat. No. 5,078,857, which is incorporated herein by reference. In the '857 patent, the delayed coking heater design puts the coil in the center of the box and burners against the wall so that the tubes could be heated from both sides, thus increasing the heat flux rate. This design also allowed for a reduction in coil length, pressure drop, and residence time, and allowed for increased capacity per coil.

Referring now to FIG. 1, a conventional, prior art, coil design used in a double-fired delayed coking heater is illustrated. The coil extends back and forth in a serpentine configuration from the heater inlet to the heater outlet, located toward the upper and lower ends of the radiant heating zone, respectively, and is generally suspended in a vertical plane between the walls of the double-fired heater.

To further increase the capacity of such coker heaters, it has been proposed to increase the diameter and/or length of the coil, such as described in Catala, K. A. et al., “Advances in Delayed Coking Heat Transfer Equipment,” Hydrocarbon Processing, February 2009, pp. 45-54. However, in new designs, the capacity can be so large that these solutions (increased diameter and/or coil length) results in one or more of higher pressure drop, higher film temperatures, higher tube metal temperature, and increased residence time, thus shortening the average run length. Alternatively, multiple heating cells may be used, which can significantly increase capital and operating expense.

### SUMMARY OF THE DISCLOSURE

It has been found that increased capacity for and/or improved operation of a delayed coking heater may be achieved by use of a multiple parallel serpentine heating coil. As used herein, a multiple parallel serpentine heating coil refers to a heating coil including multiple flow conduits arranged in a serpentine (back and forth), continuous path of horizontal tubing, which may be suspended generally in a vertical plane in the radiant heating section of a delayed coking heater.

The flow of feedstock to a heater cell may be split upstream of the heater and fed to inlets of the multiple parallel serpentine heating coil. The two or more parallel flow conduits are arranged in a way that the streams are heated symmetrically (relatively uniformly over the entire path). The heated feedstock flowing through the two or more flow conduits of the multiple parallel serpentine heating coil may then be combined outside the heater for downstream processing. The overall charge is therefore heated in a shorter flow path, resulting in a decreased residence time, decreased pressure drop, and an increase in capacity and/or average run length.

In one aspect, embodiments disclosed herein relate to a delayed coking heater for heating a feedstock to delayed coking temperature. The coking heater may include: a heater including a radiant heating zone comprising a lower portion including a hearth burner section and an upper portion including a wall burner section, the hearth burner section comprising a plurality of hearth burners located adjacent to the bottom hearth for firing in the radiant heating zone; and the wall burner section comprising a plurality of wall burners located adjacent to opposing walls; and a multiple parallel serpentine heating coil located in the radiant heating zone.

In another aspect, embodiments disclosed herein relate to a delayed coking heater for heating a feedstock to delayed coking temperature. The delayed coking heater may include: a heating vessel having upper and lower radiant heating sections, a vertical multiple parallel serpentine heating coil disposed between and spaced apart from opposite side walls of the heating vessel through which the feedstock is transported, and a plurality of burners located in the lower radiant section of the heating vessel on each side of the multiple parallel serpentine heating coil so as to be capable of providing and directing sheets of flame upwardly on opposite sides of the multiple parallel serpentine heating coil, the sheets of flame each individually lying in a plane generally parallel to the plane in which the multiple parallel serpentine heating coil is suspended.

In some embodiments, the heater may also include one or more of the following:

a flow splitter for splitting the flow of the feedstock into multiple corresponding inlets of the multiple parallel serpentine heating coil; a flow mixer for combining the heated feedstock from multiple corresponding outlets of the multiple parallel serpentine heating coil; a temperature sensor located downstream of the flow mixer for measuring a temperature of the combined heated feedstock; and a control system for adjusting an operating parameter of the delayed coking heater based on the measured temperature of the combined heated feedstock.

In another aspect, embodiments disclosed herein relate to a process for heating a feedstock in a delayed coking heater to delayed coking temperature. The process may include: splitting a flow of a feedstock into inlets of a multiple parallel serpentine heating coil vertically disposed in a delayed coking heater, the delayed coking heater comprising: a heating vessel having upper and lower radiant heating sections, the vertical multiple parallel serpentine heating coil disposed between and spaced apart from opposite side walls of the heating vessel through which the feedstock is transported, and a plurality of burners located in the lower radiant section of the heating vessel on each side of the multiple parallel serpentine heating coil so as to be capable of providing and directing sheets of flame upwardly on opposite sides of the multiple parallel serpentine heating coil, the sheets of flame each individually lying in a plane generally parallel to the plane in which the multiple parallel serpentine heating coil is suspended; heating the feedstock to delayed coking temperature in the multiple parallel serpentine heating coil; recovering heated feedstock from corresponding outlets of the multiple parallel serpentine heating coil; and combining the flow of the heated feedstock from the multiple corresponding outlets outside of the heating vessel.

The process may also include one or more of measuring a temperature of the combined heated feedstock; and adjusting an operating parameter of the delayed coking heater based on the measured temperature of the combined heated feedstock.

Other aspects and advantages will be apparent from the following description and the appended claims.

### BRIEF DESCRIPTION OF DRAWINGS

FIG. 1 illustrates a conventional, prior art, coil design used in a double-fired delayed coking heater.

FIG. 2 illustrates a delayed coking heater having a multiple parallel serpentine coil useful in embodiments disclosed herein.

FIG. 3 illustrates a multiple parallel serpentine coil design useful in a double-fired delayed coking heater according to embodiments disclosed herein.

### DETAILED DESCRIPTION

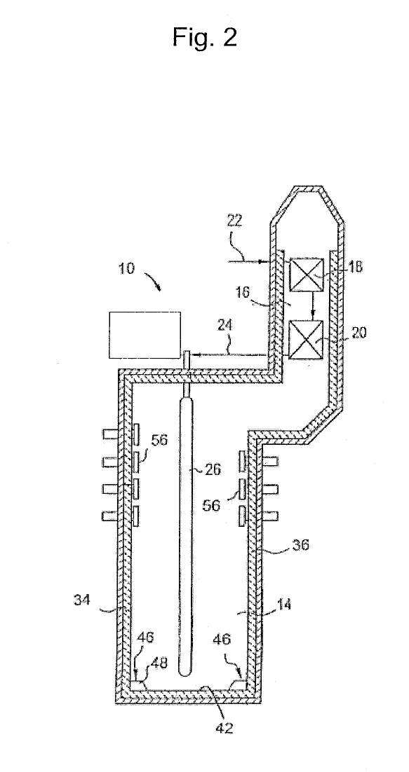

Referring now to FIG. 2, a delayed coking heater useful in embodiments disclosed herein is illustrated. FIG. 2 shows a cross section of a delayed coking heater 10. Delayed coking heater 10 has a radiant heating zone 14, and in some embodiments may include a convection heating zone 16. Located in the convection heating zone 16 are the heat exchange surfaces 18 and 20, which may be used for preheating the feedstock fed via flow line 22. The preheated feed from the convection zone is fed at 24 to a multiple parallel serpentine heating coil generally designated 26, located in the radiant heating zone 14. The heated feedstock may be recovered from the multiple parallel serpentine heating coil 26 proximate the lower end of the radiant heating zone (outlet not illustrated). The radiant heating zone 14 may include walls designated 34 and 36 and a floor or hearth 42. Mounted on the floor are the vertically firing hearth burners 46 which are directed up inside radiant heating zone 14. Each burner 46 is housed within a tile 48 on the hearth 42 against one of the walls 34 and 36. In addition to the hearth burners, the wall burners 56 are included in the upper part of the firebox. The wall burners 56 are mounted on the walls.

Other delayed coking heaters may also be used, such as those disclosed in U.S. Pat. No. 5,078,857, and those disclosed in Catala, K. A. et al., “Advances in Delayed Coking Heat Transfer Equipment,” Hydrocarbon Processing, February 2009, pp. 45-54, each of which is incorporated herein by reference.

Multiple parallel serpentine heating coil 26 may include two or more flow conduits arranged in a back and forth continuous path of horizontal tubing suspended generally in a vertical plane in the heating vessel. The continuous flow path may extend from multiple inlets in the upper portion of the radiant heating section of the heating vessel downwardly to multiple corresponding outlets located in the lower portion of the radiant heating section of the heating vessel.

Referring now to FIG. 2, a multiple parallel serpentine heating coil useful in a double-fired delayed coking heater according to embodiments disclosed herein is illustrated. Multiple parallel serpentine heating coil 26, as illustrated, includes two flow conduits 27, 28. The flow conduits 27, 28 are arranged in a generally symmetrical, serpentine (back and forth) flow path, where the arrangement may provide for relatively uniform heating of the feedstock traversing through the heater in each of the flow conduits.

While only two flow conduits are illustrated in FIG. 2, multiple parallel serpentine heating coil 26 may include 3, 4, 5, 6, or more flow conduits arranged in a similar fashion.

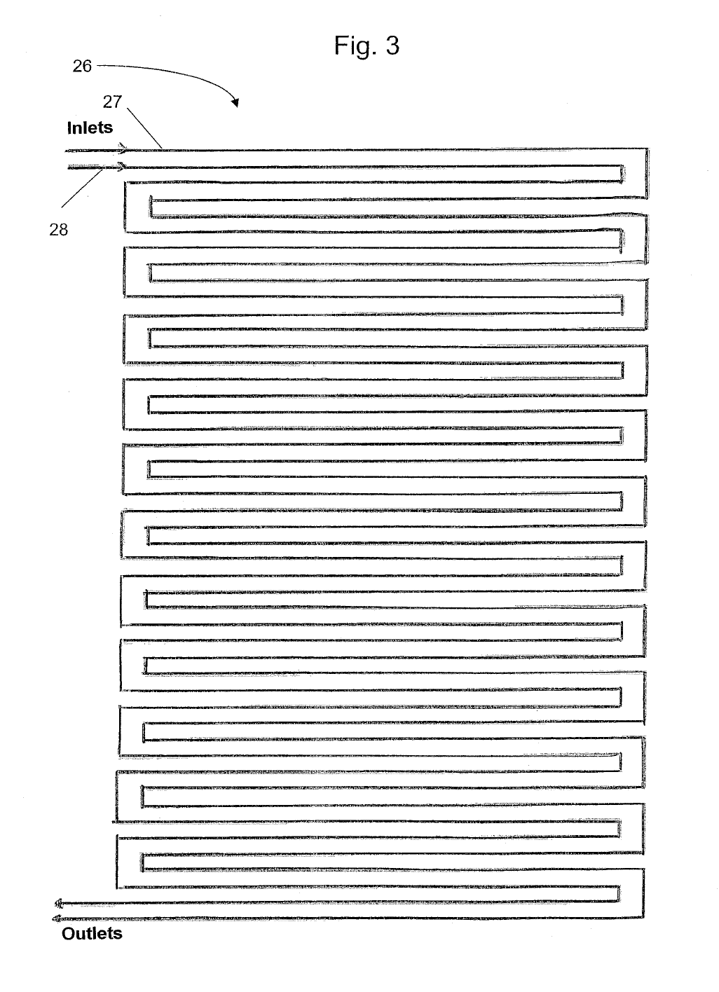

Referring to FIGS. 2 and 3, in operation, the feedstock that is to be subsequently subjected to coking in a coke drum, such as a heavy oil, bitumen, and other “residue streams,” is introduced into the tubing of the convection section 16 through the flow line 22. The feedstock then passes through the heat exchange surfaces 18, 20, to the lower portion of the convection section and then to flow line 24. The flow may then be split into the inlets of multiple parallel serpentine heating coil 26 located in the radiant heating section 14. The feedstock then travels through the multiple parallel serpentine heating coil to the outlets (not illustrated) of the radiant heating section 14. The burners 46, 56 provide flames on each side of the multiple parallel serpentine heating coil 26 within the radiant heating section 14. The hot gases from the radiant heating section 14 pass upwardly from the radiant heating section 14 through an outlet and into the convection heating section 16. Accordingly, as the feedstock is initially introduced into the convection heating section 16, it is initially heated by the hot gases from the radiant section 14 and then is exposed to increasingly hotter temperatures as it moves through the radiant heating section 14 to the outlets of the multiple parallel serpentine heating coil 26 proximate the lower end of the radiant heating section 14. The particular feed rate and the outlet temperature of the feedstock can be selected as conditions require. Typically, the device would be operated so that the coking feedstock exiting the outlet of the radiant section would be at a temperature in the range of about 800 to about 1050° F., such as about 850 to about 975° F.

The flow from the outlets of the multiple parallel serpentine heating coil may then be combined and fed to the coke drum for further processing. A temperature sensor located downstream of the flow mixer may be used for measuring a temperature of the combined heated feedstock, and a control system may be used for adjusting one or more operating parameters of the delayed coking heater, such as feedstock flow rate, fuel and/or oxygen flow rates to the burners, and other parameters as known to one skilled in the art, based on the measured temperature of the combined heated feedstock

Advantageously, use of a multiple parallel serpentine heating coil as disclosed herein may provide for one or more of the following: increased delayed coking heater capacity; decreased pressure drop through the heating coil in the radiant heating zone; reduced tube diameter for the heating coil in the radiant heating zone; lower film temperatures in the heating coil located in the radiant heating zone; thinner tube walls for the heating coil in the radiant heating zone, lower tube metal temperatures for the heating coil in the radiant heating zone; and increased run lengths, among other possible advantages.

It has been surprisingly discovered that the multiple parallel serpentine heating coil results in a significantly reduced residence time of feedstock in the radiant heating zone. For example, the residence time of the multiple parallel serpentine heating coil of the present invention, compared with that of a traditional heating coil, is almost fifty percent shorter as shown in the following example.

### Example 1

Operation of a delayed coking heater having a conventional radiant heating coil is compared to the same heater having a multiple parallel serpentine heating coil according to embodiments disclosed herein. Flow of feedstock is equivalent for both cases.

The multiple parallel serpentine heating coil includes two flow conduits, similar to that illustrated in FIG. 3, having a 3.75 inch outer diameter, an average wall thickness of 0.33 inches, and an inner diameter of 3.09 inches. The two parallel flow conduits of the multiple parallel serpentine heating coil each make 24 horizontal passes through the radiant heating section.

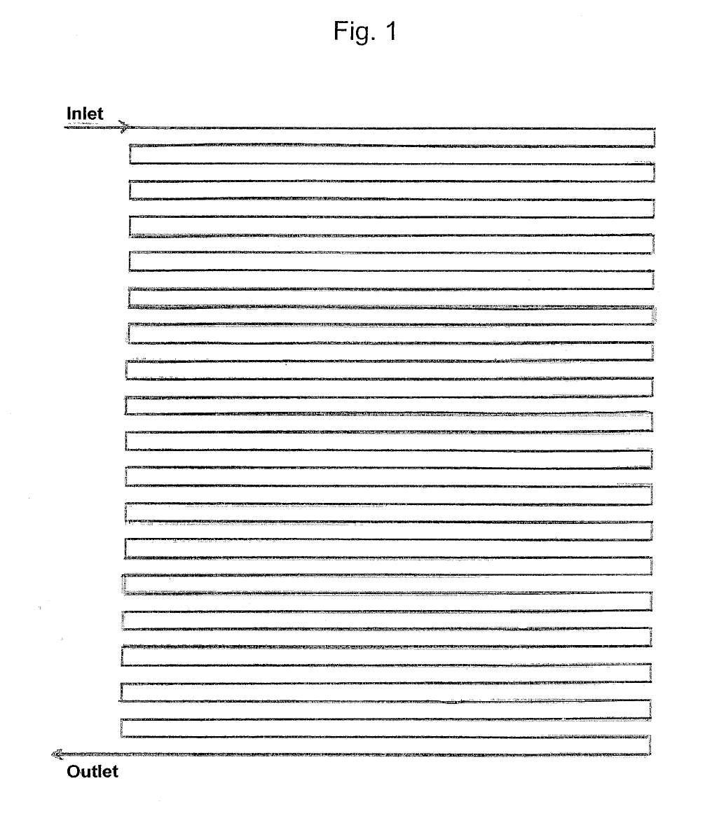

The conventional radiant heating coil, similar to that illustrated in FIG. 1, includes has a 5.15 inch outer diameter, an average wall thickness of 0.39 inches, and an inner diameter of 4.37 inches. The conventional radiant heating coil makes 36 passes through the radiant heating section.

The performance of the delayed coking heater having a multiple parallel serpentine heating coil is shown in Table 1. The performance of the delayed coking heater having a conventional radiant heating coil is shown in Table 2.

As shown, the multiple parallel serpentine heating coil of the present invention results in a total reduction in residence time from almost 63 seconds to about 40 seconds. In addition, the smaller tubes allow for a more compact design and utilize an overall lower amount of costly raw materials.

The shorter residence time allows for better cracking and reduces the amount of unwanted byproducts in the cracked effluent, providing a more valuable effluent with a better yield and a decreased need for separation of the unwanted impurities.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

TABLE 1
3.75 OD × 0.33 AW 3.09 ID

| Tube | Velocity | Avg | Temp | Res. Time |
|---|---|---|---|---|
| 0 | 71.65 | | 503.98 | |
| 1 | 45.06 | 58.355 | 501.85 | 0.278982 |
| 2 | 34.94 | 40 | 499.59 | 0.407 |
| 3 | 29.14 | 32.04 | 497.26 | 0.508115 |
| 4 | 25.2 | 27.17 | 494.88 | 0.59919 |
| 5 | 22.32 | 23.76 | 492.44 | 0.685185 |
| 6 | 20.13 | 21.225 | 489.94 | 0.76702 |
| 7 | 18.29 | 19.21 | 487.42 | 0.847475 |
| 8 | 16.69 | 17.49 | 484.9 | 0.930818 |
| 9 | 15.31 | 16 | 482.18 | 1.0175 |
| 10 | 14.17 | 14.74 | 479.07 | 1.104478 |
| 11 | 13.11 | 13.64 | 475.94 | 1.193548 |
| 12 | 12.1 | 12.605 | 472.81 | 1.291551 |
| 13 | 11.12 | 11.61 | 469.68 | 1.402239 |
| 14 | 10.14 | 10.63 | 466.54 | 1.531515 |
| 15 | 9.16 | 9.65 | 463.4 | 1.687047 |
| 16 | 8.35 | 8.755 | 459.61 | 1.859509 |
| 17 | 7.64 | 7.995 | 455.53 | 2.036273 |
| 18 | 6.91 | 7.275 | 451.44 | 2.237801 |
| 19 | 6.15 | 6.53 | 447.35 | 2.493109 |
| 20 | 5.35 | 5.75 | 443.26 | 2.831304 |
| 21 | 4.83 | 5.09 | 438.21 | 3.198428 |
| 22 | 4.55 | 4.69 | 432.51 | 3.471215 |
| 23 | 4.27 | 4.41 | 426.81 | 3.69161 |
| 24 | 3.98 | 4.125 | 421.12 | 3.946667 |
| | | | | 40.01758 |

TABLE 2
5.15 OD × 0.39 AW 4.37 ID

| Tube | Velocity | Avg | Temp | Res. Time |
|---|---|---|---|---|
| 0 | 71.64 | | 503.98 | |
| 1 | 50.36 | 61 | 502.53 | 0.267705 |
| 2 | 40.6 | 45.48 | 501 | 0.359059 |
| 3 | 34.66 | 37.63 | 499.43 | 0.433962 |
| 4 | 30.51 | 32.585 | 497.83 | 0.501151 |
| 5 | 27.4 | 28.955 | 496.2 | 0.563979 |
| 6 | 24.93 | 26.165 | 494.56 | 0.624116 |
| 7 | 22.9 | 23.915 | 492.9 | 0.682835 |
| 8 | 21.28 | 22.09 | 491.17 | 0.739249 |
| 9 | 19.87 | 20.575 | 489.45 | 0.793682 |
| 10 | 18.6 | 19.235 | 487.72 | 0.848973 |
| 11 | 17.46 | 18.03 | 485.98 | 0.905713 |
| 12 | 16.4 | 16.93 | 484.25 | 0.96456 |
| 13 | 15.46 | 15.93 | 482.35 | 1.02511 |
| 14 | 14.66 | 15.06 | 480.2 | 1.084329 |
| 15 | 13.9 | 14.28 | 478.05 | 1.143557 |
| 16 | 13.18 | 13.54 | 475.9 | 1.206056 |
| 17 | 12.47 | 12.825 | 473.75 | 1.273294 |
| 18 | 11.79 | 12.13 | 471.59 | 1.346249 |
| 19 | 11.11 | 11.45 | 469.44 | 1.426201 |
| 20 | 10.44 | 10.775 | 467.28 | 1.515545 |
| 21 | 9.76 | 10.1 | 165.12 | 1.616832 |
| 22 | 9.07 | 9.415 | 462.95 | 1.734466 |
| 23 | 8.52 | 8.795 | 460.31 | 1.856737 |
| 24 | 8.03 | 8.275 | 457.5 | 1.973414 |
| 25 | 7.53 | 7.78 | 454.69 | 2.098972 |
| 26 | 7.02 | 7.275 | 451.88 | 2.244674 |
| 27 | 6.5 | 6.76 | 449.06 | 2.41568 |
| 28 | 5.97 | 6.235 | 446.25 | 2.619086 |
| 29 | 5.4 | 5.685 | 443.43 | 2.872471 |
| 30 | 4.96 | 5.18 | 440.23 | 3.15251 |
| 31 | 4.76 | 4.86 | 436.3 | 3.360082 |
| 32 | 4.56 | 4.66 | 432.38 | 3.504292 |
| 33 | 4.36 | 4.46 | 428.45 | 3.661435 |
| 34 | 4.17 | 4.265 | 424.53 | 3.828839 |
| 35 | 3.98 | 4.075 | 420.58 | 4.007362 |
| 36 | 3.92 | 3.95 | 416.15 | 4.134177 |
| | | | | 62.78635 |

1: A delayed coking heater for heating a feedstock to delayed coking temperature comprising:
a heater including a radiant heating zone comprising a lower portion including a hearth burner section and an upper portion including a wall burner section, the hearth burner section comprising a plurality of hearth burners located adjacent to the bottom hearth for firing in the radiant heating zone; and the wall burner section comprising a plurality of wall burners located adjacent to opposing walls; and
a multiple parallel serpentine heating coil located in the radiant heating zone.

2: A delayed coking heater for heating a feedstock to delayed coking temperature comprising:
a heating vessel having upper and lower radiant heating sections, a vertical multiple parallel serpentine heating coil disposed between and spaced apart from opposite side walls of the heating vessel through which the feedstock is transported, and a plurality of burners located in the lower radiant section of the heating vessel on each side of the multiple parallel serpentine heating coil so as to be capable of providing and directing sheets of flame upwardly on opposite sides of the multiple parallel serpentine heating coil, the sheets of flame each individually lying in a plane generally parallel to the plane in which the multiple parallel serpentine heating coil is suspended.

3: The delayed coking heater of claim 1, further comprising a flow splitter for splitting the flow of the feedstock into inlets of the multiple parallel serpentine heating coil.

4: The delayed coking heater of claim 1, further comprising a flow mixer for combining the heated feedstock from corresponding outlets of the multiple parallel serpentine heating coil.

5: The delayed coking heater of claim 4, further comprising a temperature sensor located downstream of the flow mixer for measuring a temperature of the combined heated feedstock.

6: The delayed coking heater of claim 1, further comprising a control system for adjusting an operating parameter of the delayed coking heater based on the measured temperature of the combined heated feedstock.

7: A process for heating a feedstock in a delayed coking heater to delayed coking temperature, comprising:
splitting a flow of a feedstock into inlets of a multiple parallel serpentine heating coil vertically disposed in a delayed coking heater, the delayed coking heater comprising:
a heating vessel having upper and lower radiant heating sections, the vertical multiple parallel serpentine heating coil disposed between and spaced apart from opposite side walls of the heating vessel through which the feedstock is transported, and a plurality of burners located in the lower radiant section of the heating vessel on each side of the multiple parallel serpentine heating coil so as to be capable of providing and directing sheets of flame upwardly on opposite sides of the multiple parallel serpentine heating coil, the sheets of flame each individually lying in a plane generally parallel to the plane in which the multiple parallel serpentine heating coil is suspended;
heating the feedstock to delayed coking temperature in the multiple parallel serpentine heating coil;
recovering heated feedstock from corresponding outlets of the multiple parallel serpentine heating coil; and
combining the flow of the heated feedstock from the multiple corresponding outlets outside of the heating vessel.

8: The process of claim 7, further comprising measuring a temperature of the combined heated feedstock.

9: The process of claim 8, further comprising adjusting an operating parameter of the delayed coking heater based on the measured temperature of the combined heated feedstock.

10: The delayed coking heater of claim 2, further comprising a flow splitter for splitting the flow of the feedstock into inlets of the multiple parallel serpentine heating coil.

11: The delayed coking heater of claim 2, further comprising a flow mixer for combining the heated feedstock from corresponding outlets of the multiple parallel serpentine heating coil.

12: The delayed coking heater of claim 11, further comprising a temperature sensor located downstream of the flow mixer for measuring a temperature of the combined heated feedstock.

13: The delayed coking heater of claim 2, further comprising a control system for adjusting an operating parameter of the delayed coking heater based on the measured temperature of the combined heated feedstock.
